(19) United States
(12) Patent Application Publication
(10) Pub. No.: US 2007/0278715 A1
(43) Pub. Date: Dec. 6, 2007

(54) IN-MOLD FORMING METHOD, IN-MOLD FORMING MOLD AND IN-MOLD FORMING APPARATUS

(75) Inventors: Hirofumi IGARASHI, Chiryu-shi (JP); Takumi Kudou, Tokyo (JP); Masaaki Iwakiri, Tokyo (JP); Yasuyuki Ohara, Nagoya-shi (JP); Isamu Sakayori, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: Koto Engraving Co., Ltd., Tokyo (JP); Tsuchiya Co., Ltd., Nagoya-shi (JP)

(21) Appl. No.: 11/755,360

(22) Filed: May 30, 2007

(30) Foreign Application Priority Data
Jun. 1, 2006 (JP) 2006-153930

(51) Int. Cl. B29C 45/14

(52) U.S. Cl. 264/259; 264/266; 425/401; 425/500

(57) ABSTRACT

A film coated with a metal foil is embossed beforehand with a shape conformed to a formed article. Injection molding is performed, with the embossed film coated with the metal foil being sandwiched between an injection molding male mold and an injection molding female mold. As a result, the metal foil of the film coated with the metal foil is transferred to a product having a deeply concavo-convex surface, without damage to the metal foil, with the quality of the product being ensured.

The entire disclosure of Japanese Patent Application No. 2006-153930 filed Jun. 1, 2006 is expressly incorporated by reference herein.

### BACKGROUND OF THE INVENTION

1. Field of the Invention

This invention relates to an in-mold forming method for decorating resin with the film pattern of a patterned film, simultaneously with injection molding of the resin, and an in-mold forming mold for use in the in-mold forming method.

The present invention also relates to an in-mold forming apparatus for decorating resin with the film pattern of a patterned film, simultaneously with injection molding of the resin.

2. Description of the Related Art

In-mold forming is known by which a patterned film provided with a film pattern (for example, a film coated with a metal foil) is inserted into a mold, and the film pattern (the metal foil) is applied for decoration (transferred) by heat and pressure during injection molding. With in-mold forming, a decorated formed article is obtained without plating or painting. Thus, this technique is advantageous to the environment, and has few restrictions as to the shape of the formed article. For these reasons, in-mold forming is finding use in many fields.

In performing in-mold forming with the use of a patterned film (e.g., a film coated with a metal foil), it is common practice to pass the film coated with the metal foil between a stationary mold and a moving mold, and inject resin into these molds where the film coated with the metal foil has been interposed, thereby obtaining an in-mold formed article (see Japanese Unexamined Patent Publication No. 2001-277294 and Japanese Unexamined Patent Publication No. 1984-202830). With the technologies disclosed in these patent documents, the formed article is obtained, for example, by passing the film coated with the metal foil, which is in a continuous shape, between the stationary mold and the moving mold, and injecting the resin between these molds and the continuous film coated with the metal foil. By carrying out in-mold forming with the use of the film coated with the metal foil, the surface of the product can be decorated with the metal foil transferred under heat and pressure during injection molding, regardless of the shape of the surface of the product, even if this surface has irregularities other than a stepped portion. With these technologies, the continuous film coated with the metal foil is heated prior to injection molding in order to prevent the breakage of the metal foil.

In recent years, product diversification and differentiation have been stepped up. In the field of in-mold formed articles as well, there has been a demand for in-mold forming of products having a deeply concavo-convex shape. By preheating a continuous film coated with a metal foil, in-mold forming can be applied to a surface having some irregularity, without breakage caused to the metal foil. Even when the continuous film coated with the metal foil is preheated, sufficient quality cannot be ensured for a product having a deeply concavo-convex surface by reliably transferring the metal foil to the product. Thus, there is a strong demand for the establishment of an in-mold forming technology which can transfer the metal foil to the product having a deeply concavo-convex surface while ensuring the quality of the product.

### SUMMARY OF THE INVENTION

The present invention has been accomplished in the light of the above-mentioned circumstances. It is an object of the present invention to provide an in-mold forming method, an in-mold forming mold, and an in-mold forming apparatus, each of which can decorate even a product having a deeply concavo-convex surface with a film pattern while ensuring the quality of the product.

A first aspect of the present invention, for attaining the above object, is an in-mold forming method, comprising:

embossing, beforehand, a patterned film with a shape conformed to a formed article; and

performing injection molding, while interposing the embossed patterned film in a forming mold, to obtain the formed article decorated with a pattern of the patterned film.

According to the first aspect, the patterned film embossed beforehand with the shape conformed to the formed article is interposed in the forming mold at the time of injection molding. Thus, even a product having a deeply concavo-convex surface can be decorated with the film pattern, without damage to the film pattern, with the quality of the product being ensured.

A second aspect of the present invention is the in-mold forming method according to the first aspect, characterized by performing the embossing of the shape conformed to the formed article, and the injection molding, by use of the same mold.

According to the second aspect, embossing of the shape conformed to the formed article, and injection molding can be performed by use of the single mold.

A third aspect of the present invention is the in-mold forming method according to the second aspect, characterized by repeating movement of the mold and intermittent feeding of the patterned film which is continuous, to repeat embossing and injection molding simultaneously.

According to the third aspect, embossing and injection molding can be repeated at the same time continuously.

A fourth aspect of the present invention is the in-mold forming method according to any one of the first to third aspects, characterized in that the patterned film is a film coated with a metal foil, and the metal foil of the film coated with the metal foil is transferred, simultaneously with forming, to obtain the formed article decorated with the metal foil.

According to the fourth aspect, the formed article having the metal foil transferred thereto can be obtained.

A fifth aspect of the present invention, for attaining the aforementioned object, is an in-mold forming mold, comprising:

a male mold body;

a film shaping male mold provided, in the male mold body, for embossing, beforehand, a patterned film with a shape conformed to a formed article;

a female mold body;

a film shaping female mold provided, in the female mold body, to oppose the film shaping male mold;

an injection molding male mold provided, in the male mold body, to be adjacent to the film shaping male mold; and

an injection molding female mold provided, in the female mold body, to oppose the injection molding male mold.

According to the fifth aspect, embossing with the shape conformed to the formed article, and injection molding are performed by the single mold comprising the male mold body and the female mold body. As a result, even a product having a deeply concavo-convex surface can be decorated with the film pattern, without damage to the film pattern, with the quality of the product being ensured.

A sixth aspect of the present invention is the in-mold forming mold according to the fifth aspect, characterized in that the film shaping male mold is provided in the male mold body via a heat insulating material, and the film shaping female mold is provided in the female mold body via a heat insulating material.

According to the sixth aspect, the film shaping male mold and the film shaping female mold are provided via heat insulating materials. Thus, they can be independently controlled to a temperature for embossing of a shape conformed to the formed article.

A seventh aspect of the present invention is the in-mold forming mold according to the fifth or sixth aspect, characterized in that the patterned film embossed and injection molded in the male mold body and the female mold body is a film coated with a metal foil, and the metal foil of the film coated with the metal foil is transferred, simultaneously with forming, to obtain the formed article decorated with the metal foil.

According to the seventh aspect, the formed article having the metal foil transferred thereto can be obtained.

An eighth aspect of the present invention, for attaining the aforementioned object, is an in-mold forming apparatus, comprising:

a stationary support stand for supporting the male mold body according to the fifth or sixth aspect;

a moving support stand for supporting the female mold body according to the fifth or sixth aspect to oppose the male mold body;

material pressure-feeding means for pressure-feeding a material for the formed article to a male mold side of the male mold body supported by the stationary support stand;

film feeding means provided, on a moving support stand side, for feeding the patterned film between the male mold body and the female mold body; and

control means for synchronizing a clamping action by movement of the moving support stand, an action of feeding the patterned film by the film feeding means, and an action of pressure-feeding the material for the formed article by the material pressure-feeding means,

the in-mold forming apparatus being arranged to perform, simultaneously,
film shaping and embossing, by the film shaping male mold and the film shaping female mold, of the patterned film to impart the shape conformed to the formed article, and
forming for obtaining the formed article decorated with a pattern of the patterned film by carrying out injection molding while sandwiching the embossed patterned film between the male mold and the female mold,
   and also to repeat feeding of the patterned film upon mold release, thereby obtaining the decorated formed article continuously.

According to the eighth aspect, even a product having a deeply concavo-convex surface can be decorated with the pattern of the patterned film, without damage to the pattern of the patterned film, with the quality of the product being ensured. The stationary support stand may support the female mold body instead of supporting the male mold body, and the moving support stand may support the male mold body instead of supporting the female mold body.

A ninth aspect of the present invention is the in-mold forming apparatus according to the eighth aspect, characterized in that the patterned film is a film coated with a metal foil, and the metal foil of the film coated with the metal foil is transferred, simultaneously with forming, to obtain the formed article decorated with the pattern of the patterned film.

According to the ninth aspect, the formed article having the metal foil transferred thereto can be obtained.

The in-mold forming method of the present invention enables even a product having a deeply concavo-convex surface to be decorated with the film pattern, with the quality of the product being ensured.

The in-mold forming mold of the present invention enables even a product having a deeply concavo-convex surface to be decorated with the film pattern, with the quality of the product being ensured.

The in-mold forming apparatus of the present invention enables even a product having a deeply concavo-convex surface to be decorated with the film pattern, with the quality of the product being ensured.

### BRIEF DESCRIPTION OF THE DRAWINGS

For a more complete understanding of the present invention and the advantages thereof, reference is now made to the following descriptions in conjunction with the accompanying drawings.

FIG. 1 is a schematic side view of an in-mold forming apparatus for performing an in-mold forming method according to an embodiment of the present invention.

FIG. 2 is a perspective view of an in-mold forming mold according to the embodiment of the present invention.

FIG. 3 is an external outline view of an example of an in-mold formed article.

FIGS. 4A and 4B are development views showing the molding surfaces of the in-mold forming mold.

FIG. 5 is a sectional view of the in-mold forming mold.

FIG. 6 is a view taken along line VI-VI in each of FIGS. 4A and 4B.

FIG. 7 is a view taken along line VII-VII in each of FIGS. 4A and 4B.

FIG. 8 is a view taken along line VIII-VIII in each of FIGS. 4A and 4B.

FIG. 9 is a process explanation drawing of the in-mold forming method according to the embodiment of the present invention.

FIG. 10 is a process explanation drawing of the in-mold forming method according to the embodiment of the present invention.

FIG. 11 is a process explanation drawing of the in-mold forming method according to the embodiment of the present invention.

### DESCRIPTION OF THE PREFERRED EMBODIMENTS

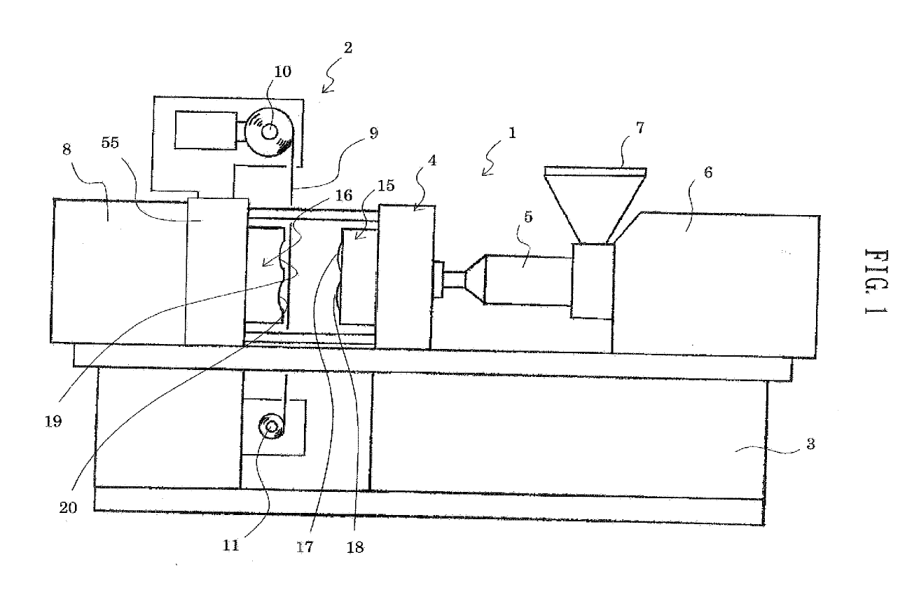

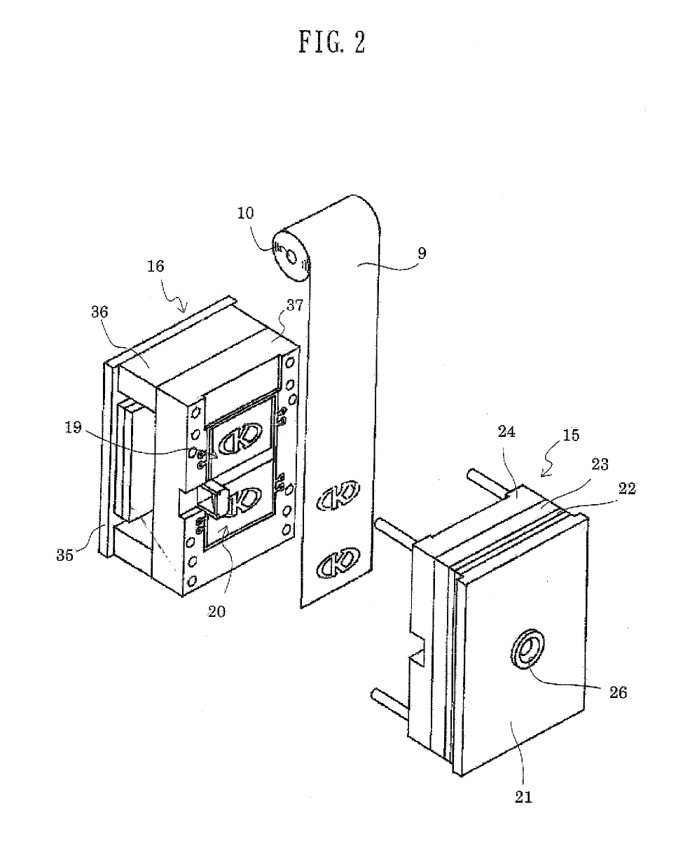

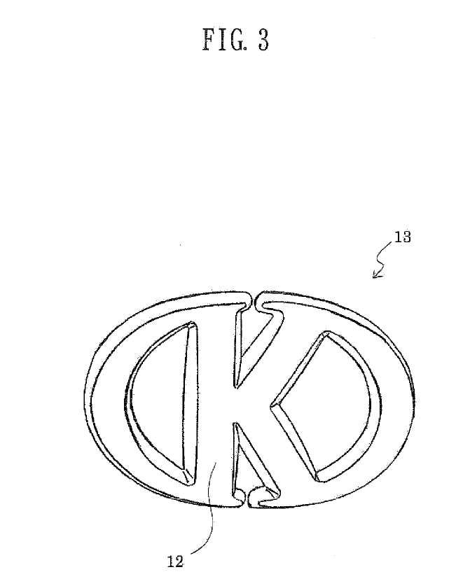

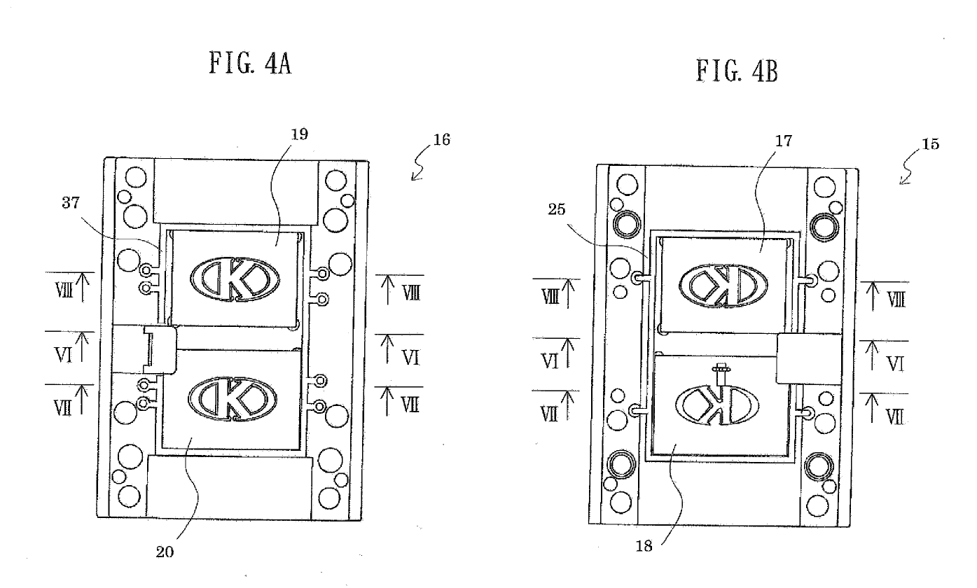

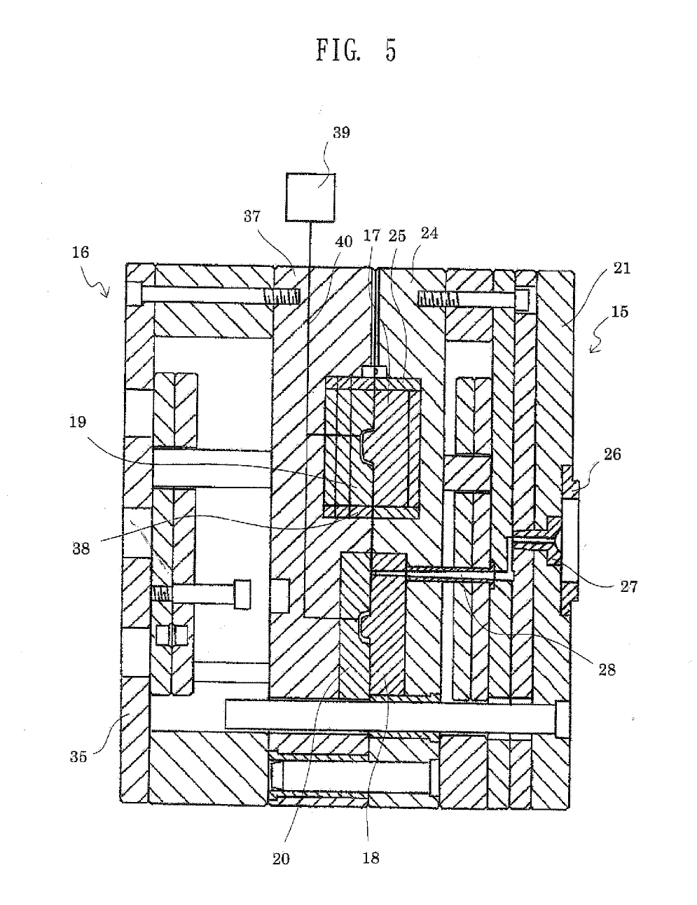

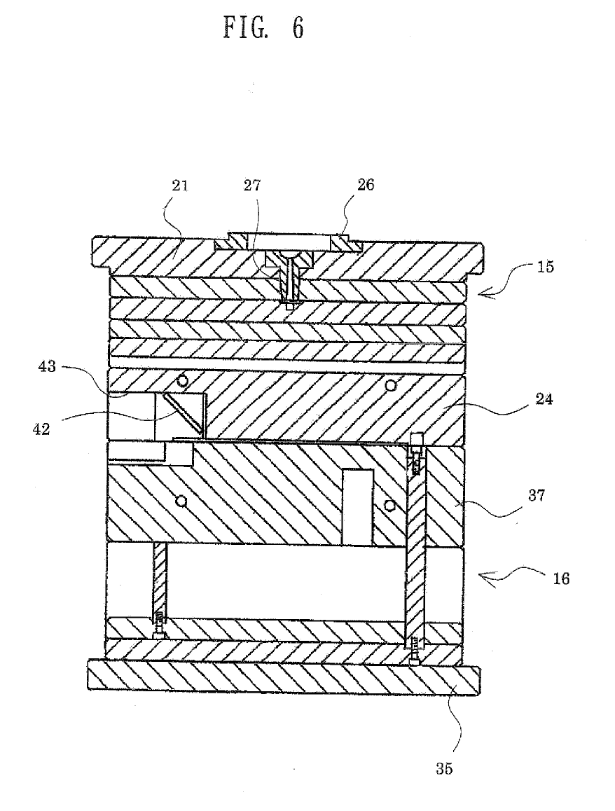

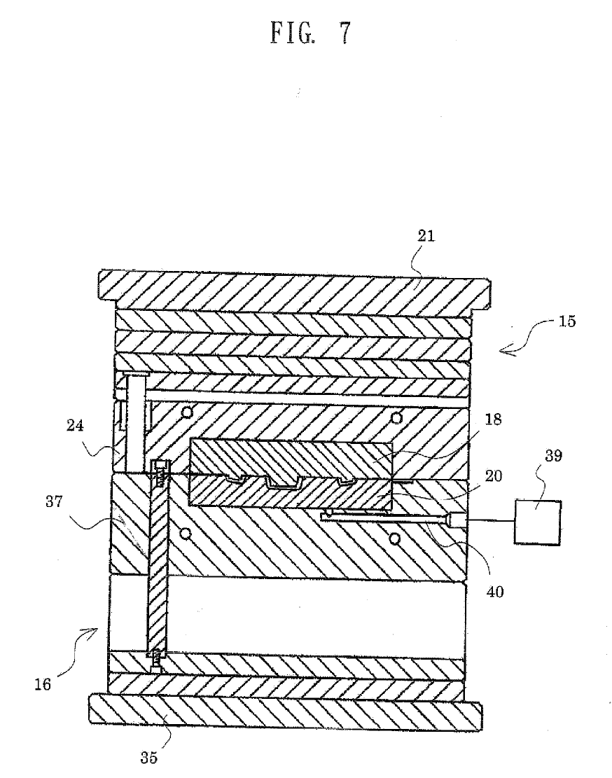

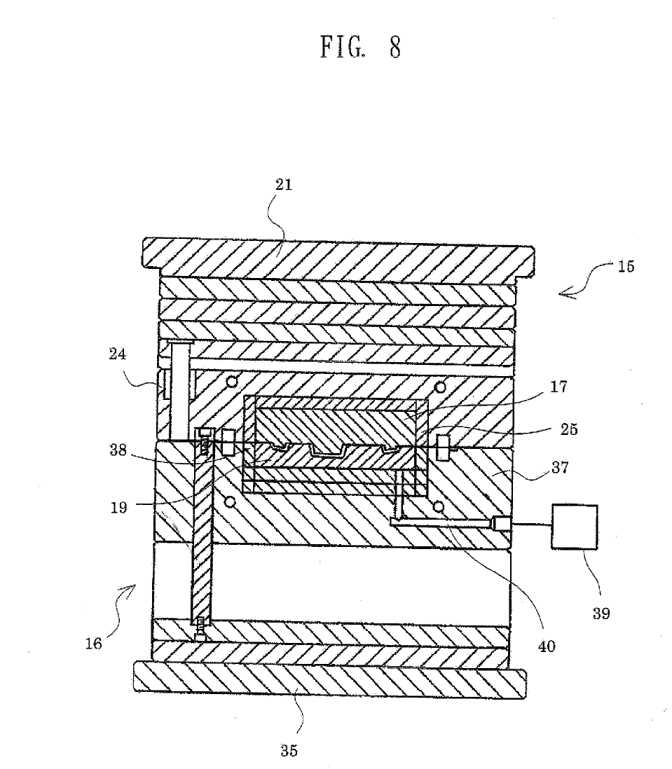

FIG. 1 shows a schematic side of an in-mold forming apparatus for performing an in-mold forming method according to an embodiment of the present invention. FIG. 2 shows the perspective status of an in-mold forming mold according to the embodiment of the present invention. FIG. 3 shows an example of an in-mold formed article. FIGS. 4A and 4B show a development status illustrating the molding surface of the in-mold forming mold. FIG. 5 shows the sectional status of the in-mold forming mold. FIG. 6 shows a status viewed along line VI-VI in each of FIGS. 4A and 4B. FIG. 7 shows a status viewed along line VII-VII in each of FIGS. 4A and 4B. FIG. 8 shows a status viewed along line VIII-VIII in each of FIGS. 4A and 4B.

The schematic configuration of the in-mold forming apparatus will be described based on FIGS. 1 and 2.

As shown in FIG. 1, an in-mold forming apparatus 1 has a film feeding device 2, as a film feeding means, mounted on an injection molding machine. A stationary die plate 4 as a stationary support stand is provided on a base 3 of the in-mold forming apparatus 1. A barrel 5 for feeding molten resin is connected to the stationary die plate 4. The barrel 5 is equipped with a feeding means such as a screw (not shown), and the feeding means is driven in a feed direction by an injection drive portion 6. A resin material charged into a hopper 7 is heated and melted, and pressure-fed with in the barrel 5 toward the stationary die plate 4 (material pressure-feeding means).

A clamping drive portion 8 is provided on a side opposite to the barrel 5 across the stationary die plate 4, and a moving die plate 55 as a moving support stand is provided on the clamping drive portion 8. The moving die plate 55 can be moved by the clamping drive portion 8 toward the stationary die plate 4. The film feeding device 2 is provided on the moving die plate 55. The film feeding device 2 is equipped with a feed roll 10 for paying out a film 9 coated with a metal foil (i.e., a patterned film), and a recovery roll 11 for recovering the film 9 coated with the metal film after transfer of the metal foil. The film 9 coated with the metal foil is intermittently fed between the stationary die plate 4 and the moving die plate 55 by the film feeding device 2.

As shown in FIGS. 1 and 2, a stationary mold body 15 serving as a male mold body is fixed to the stationary die plate 4, while a moving mold body 16 serving as a female mold body and opposing the stationary mold body 15 is fixed to the moving die plate 55. The stationary mold body 15 is provided with a film shaping male mold 17 for embossing, beforehand, the film 9 coated with the metal foil to impart thereto a shape conformed to a formed article. The stationary mold body 15 is also provided with an injecting molding male mold 18 disposed below and adjacent to the film shaping male mold 17. The moving mold body 16 is provided with a film shaping female mold 19 for embossing, beforehand, the film 9 coated with the metal foil to impart thereto a shape conformed to the formed article, the film shaping female mold 19 opposing the film shaping male mold 17. The moving mold body 16 is also provided with an injecting molding female mold 20 disposed below and adjacent to the film shaping female mold 19 such that the injection molding female mold 20 opposes the injection molding male mold 18.

Molten resin is pressure-fed from the barrel 5 to the injection molding male mold 18, and a vacuum device (not shown) is connected to the film shaping female mold 19 and the injection molding female mold 20. The moving die plate 55 is sent toward the stationary die plate 4, and the stationary mold body 15 and the moving mold body 16 are clamped against each other, with the film 9 coated with the metal foil being sandwiched therebetween. At this time, the film 9 coated with the metal foil is embossed beforehand by the film shaping male mold 17 and the film shaping female mole 19 and, simultaneously, the molten resin is pressure-fed between the injection molding male mold 18 and the injection molding female mold 20, with the result that a formed article 13 (see FIG. 3) having a metal foil 12 (see FIG. 3) transferred on to the surface thereof is obtained.

The stationary mold body 15 and the moving mold body 16, which constitute an in-mold forming mold, will be described concretely based on FIG. 2 and FIGS. 4A, 4B to FIG. 8.

The stationary mold body 15 has a stationary mounting plate 21 fixed to the stationary die plate 4, and a male mold support 24 is fixed to the stationary mounting plate 21. The film shaping male mold 17 and the injection molding male mold 18 are mounted on the male mold support 24. The film shaping male mold 17 is fixed to the male mold support 24 via a heat insulating material 25.

Since the film shaping male mold 17 is mounted on the male mold support 24 via the heat insulating material 25, the film shaping male mold 17 can be maintained at a temperature for embossing of the film 9 coated with the metal foil, without influence from the temperature during injection molding, although the injection molding male mold 18 is mounted on the same male mold support 24.

A locating ring 26, into which the nozzle of the barrel 5 (see FIG. 1) is fitted, is provided on the rear side (right-hand side in FIG. 5) of the stationary mounting plate 21. In the stationary mounting plate 21, a sprue bushing 27 is provided in correspondence with the locating ring 26. A resin channel 28 communicating with the sprue bushing 27 is provided in the injection molding male mold 18. The molten resin from the sprue bushing 27 is sent through the resin channel 28 into a cavity between the injection molding male mold 18 and the injection molding female mold 20.

The moving mold body 16 has a moving mounting plate 35 fixed to the moving die plate 55, and a female mold support 37 is fixed to the moving mounting plate 35. The film shaping female mold 19 and the injection molding female mold 20 are mounted on the female mold support 37. The film shaping female mold 19 is fixed to the female mold support 37 via a heat insulating material 38.

Since the film shaping female mold 19 is mounted on the female mold support 37 via the heat insulating material 38, the film shaping female mold 19 can be maintained at a temperature for embossing of the film 9 coated with the metal foil, without influence from the temperature during injection molding, although the injection molding female mold 20 is mounted on the same female mold support 37.

A vacuum means 39 is connected to the film shaping female mold 19 and the injection molding female mold 20 of the female mold support 37 via a vacuum passage 40 (see FIG. 5, FIG. 7 and FIG. 8). A cavity between the film shaping male mold 17 and the film shaping female mold 19, and a cavity between the injection molding male mold 18 and the injection molding female mold 20 are brought to a predetermined vacuum atmosphere by the vacuum means 39.

As shown in FIG. 2, FIGS. 4A, 4B, and FIG. 6, a mirror 42 is provided in an end portion of the female mold support 37 located between the film shaping female mold 19 and the injection molding female mold 20. In the stationary mold body 15, a fitting portion 43 where the mirror 42 is disposed is formed. When the moving mold body 16 and the stationary mold body 15 are clamped against each other, with the film 9 coating with the metal foil being sandwiched therebetween, the mirror 42 enables the feeding position of the film 9 coated with the metal foil to be confirmed, so that this feeding position can be easily aligned with the position of the embossing site and the position of the injection molding male mold 18 and the injection molding female mold 20.

It is also possible to provide a means for automatically recognizing the feeding position of the film 9 coated with the metal foil via the mirror 42, and synchronize the action of the feed roll 10 (see FIG. 1) (the action of the film feeding device 2) with the actions of the above members in accordance with the results of the recognition.

In the in-mold forming mold described above, single clamping performs embossing, by the film shaping male mold 17 and the film shaping female mold 19, of a shape conformed to a desired formed article onto the film 9 coated with the metal foil, and injection molding (transfer) by the injection molding male mold 18 and the injection molding female mold 20, with the embossed site being sandwiched therebetween.

Since the injection molding is carried out, with the embossed film 9 coating with the metal foil being held between the injection molding male mold 18 and the injection molding female mold 20, the metal foil (film pattern) is not damaged, and the metal foil can be transferred (for decoration) even to a product having a deeply concavo-convex surface, with its quality being ensured. Furthermore, the single in-mold forming mold is capable of embossing and injection molding, so that single clamping can simultaneously carry out embossing and injection molding, with the film 9 coating with the metal foil being sandwiched.

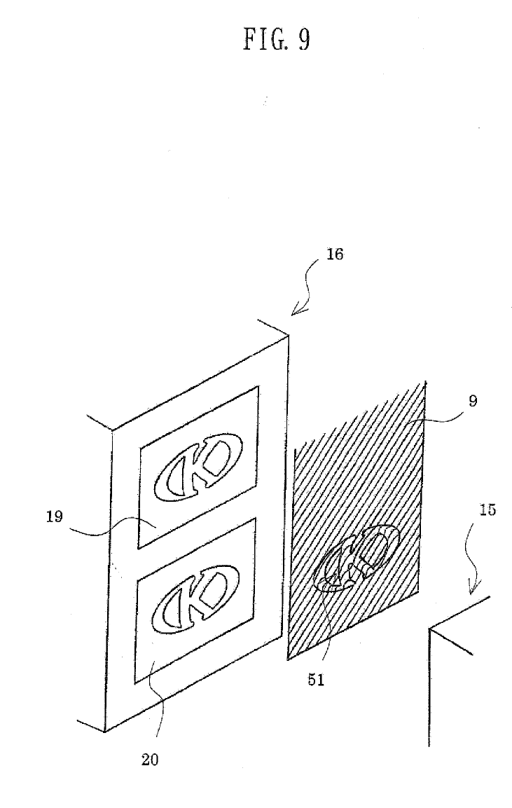

The process of an in-mold forming method by the in-mold forming apparatus having the in-mold forming mold described above will be described based on FIGS. 9 to 11. FIGS. 9 to 11 illustrate the process of the in-mold forming method according to the embodiment of the present invention.

Prior to injection molding, the film 9 coated with the metal foil is interposed between the film shaping male mold 17 (see FIG. 5) and the film shaping female mold 19, and the moving die plate 55 (see FIG. 1) is moved to carry out clamping of the stationary mold body 15 and the moving mold body 16. By so doing, an embossed portion 51 of a shape conformed to the formed article (see FIG. 3) is formed, as shown in FIG. 9. The film shaping male mold 17 heat-insulated by the heat insulating material 25 (see FIG. 5) and the film shaping female mold 19 heat-insulated by the heat insulating material 38 are independently controlled to a temperature for embossing, and the cavity between them is held in a predetermined vacuum state.

After completion of the clamping for the predetermined embossing, the moving die plate 55 is retreated for unclamping of the stationary mold body 15 and the moving mold body 16, and the feed roll 10 (see FIG. 1) of the film feeding device 2 (see FIG. 1) is actuated to move the embossed portion 51 to the position of the injection molding male mold 18 (see FIG. 5) and the injection molding female mold 20. At this time, the moving die plate 55 is retreated by a sufficient distance so that the embossed portion 51 of a thickness corresponding to the depth of the concavo-convex region can move. As a result, the stationary mold body 15 and the moving mold body 16 are unclamped. For example, the moving die plate 55 is retreated in a plurality of steps (2 steps) to carry out mold unclamping.

After the embossed portion 51 is moved, the moving die plate 55 (see FIG. 1) is moved to clamp the stationary mold body 15 and the moving mold body 16 against each other, while sandwiching the film 9 coated with the metal foil, where the embossed portion 51 has been formed, between the stationary mold body 15 and the moving mold body 16. By this action, another embossed portion 51 is formed by the film shaping male mold 17 (see FIG. 5) and the film shaping female mold 19. At the same time, injection molding (transfer) is carried out, with the embossed portion 51 already formed being sandwiched between the injection molding male mold 18 (see FIG. 5) and the injection molding female mold 20.

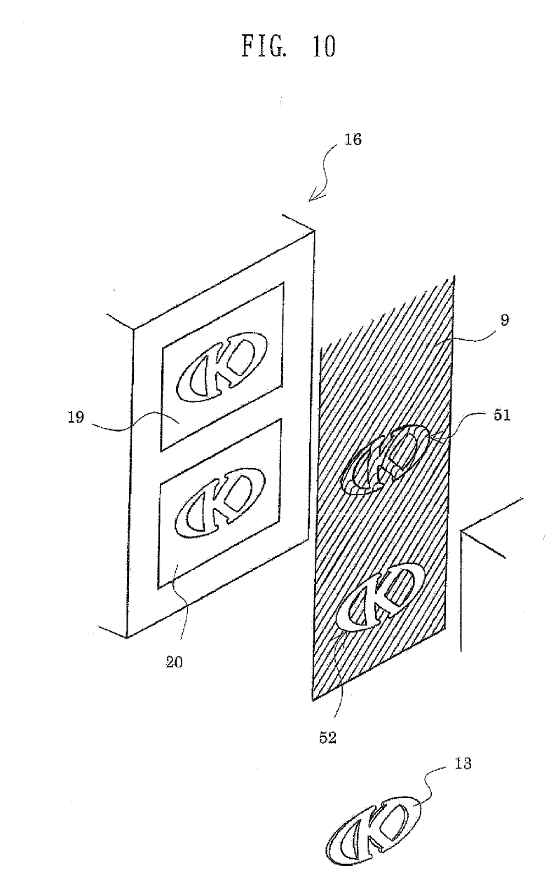

After the injection molding and the transfer of the metal foil are completed, the stationary mold body 15 and the moving mold body 16 are unclamped, and the resulting formed article 13 is ejected from the mold. As shown in FIG. 10, a transfer site 52 devoid of the metal foil is left in the embossed portion 51 of the film 9 coated with the metal foil and, simultaneously, a new embossed portion 51 is formed. The ejection of the formed article 13 can be performed by an ejection mechanism using a fluid, or can be performed by applying tension to the film 9 coated with the metal foil.

The feed roll 10 of the film feeding device 2 (see FIG. 1) is actuated to move the new embossed portion 51 to the position of the injection molding male mold 18 (see FIG. 5) and the injection molding female mold 20. In this state, the moving die plate 55 (see FIG. 1) is moved to clamp the stationary mold body 15 and the moving mold body 16 against each other, while sandwiching the film 9 coated with the metal foil, where the new embossed portion 51 has been formed, between the stationary mold body 15 and the moving mold body 16. By this action, another embossed portion 51 is formed by the film shaping male mold 17 (see FIG. 5) and the film shaping female mold 19. At the same time, the embossed portion 51 already formed is sandwiched between the injection molding male mold 18 (see FIG. 5) and the injection molding female mold 20 for injection molding (transfer).

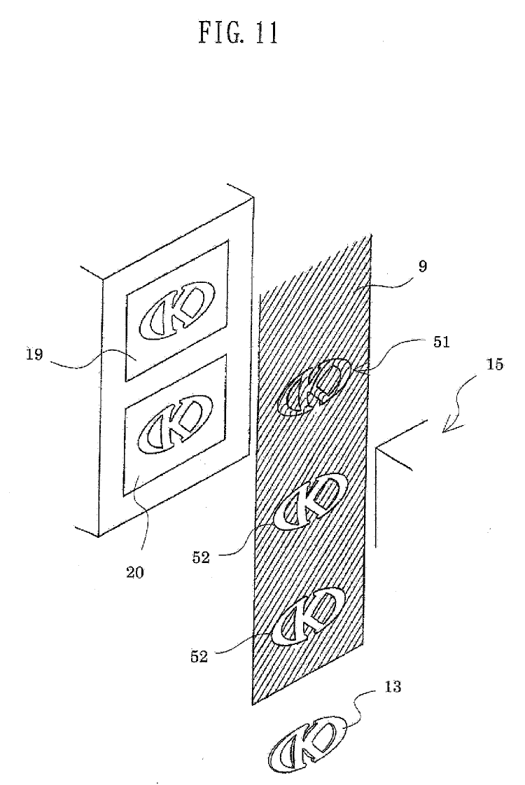

In the same manner as described earlier, after the injection molding and the transfer of the metal foil are completed, the stationary mold body 15 and the moving mold body 16 are unclamped, and a newly formed article 13 is ejected from the mold. As shown in FIG. 11, a new transfer site 52 devoid of the metal foil is left in the new embossed portion 51 of the film 9 coated with the metal foil and, simultaneously, a new embossed portion 51 is further formed.

By repeating the above-described procedure, it becomes possible to simultaneously perform the film shaping and embossing, by the film shaping male mold 17 (see FIG. 5) and the film shaping female mold 19, of the film 9 coating with the metal foil for imparting a shape conformed to the formed article; and forming for obtaining the formed article 13, which has the metal foil transferred thereto, by injection molding while sandwiching the embossed portion 51 between the injection molding male mold 18 (see FIG. 5) and the injection molding female mold 20. By repeating the feed of the film 9 coated with the metal foil upon mold release, the formed articles 13 each having the metal foil transferred thereto can be continuously obtained.

Thus, embossing of a shape conformed to the formed article 13, and injection molding involving transfer of the metal foil can be performed simultaneously and continuously by the single mold. Furthermore, the film shaping male mold 17 and the film shaping female mold 19 are mounted on the male mold support 24 and the female mold support 37 via the heat insulating materials 25 and 38. Thus, the film shaping male mold 17 and the film shaping female mold 19 can be independently controlled to a temperature for embossing the film 9 having the metal foil with the shape conformed to the formed article 13.

According to the above-described in-mold forming apparatus, injection molding is carried out, with the film 9 having the metal foil, which has been embossed with the shape conformed to the formed article 13, being sandwiched between the injection molding male mold 18 and the injection molding female mold 20 of the stationary mold body 15 and the moving mold body 16. Thus, the metal foil of the metal foil-coated film 9 is not damaged. Even for a product having a deeply concavo-convex surface, such as the formed article 13 having deep irregularities (e.g., irregularities of a depth of the order of 3 to 10 mm) at sites where angles formed by letters and edge portions are small, the metal foil of the metal foil-coated film 9 can be transferred, without damage, with the quality of the product being ensured.

As described above, the present invention can be utilized in the industrial fields of an in-mold forming method for decorating resin with a film pattern, simultaneously with injection molding of the resin, and an in-mold forming mold for use in the in-mold forming method.

The present invention can also be utilized in the industrial field of an in-mold forming apparatus for decorating resin with a film pattern, simultaneously with injection molding of the resin.

Although the present invention has been described by the above embodiments, it should be understood that the invention is not limited to these embodiments, but may be varied in many ways. For example, in the foregoing embodiments, in-mold forming, which uses the metal foil-coated film 9 as a patterned film and transfers the metal foil as a film pattern, has been taken as an example for illustration. However, the present invention can also be applied to other type of in-mold forming in which a picture design or a letter design is transferred. Moreover, in-mold forming, which transfers the metal foil while leaving the film having a base pattern, has been taken as an example for illustration. However, the present invention can also be applied to in-mold forming in which a patterned film is transferred, unchanged, for decoration of a product. Such changes, substitutions and alterations can be made therein without departing from the spirit and scope of the invention as defined by the appended claims.

What is claimed is:

1. An in-mold forming method, comprising:
embossing, beforehand, a patterned film with a shape conformed to a formed article; and
performing injection molding, while interposing the embossed patterned film in a forming mold, to obtain the formed article decorated with a pattern of the patterned film.

2. The in-mold forming method according to claim 1, further comprising:
performing the embossing of the shape conformed to the formed article, and the injection molding, by use of the same mold.

3. The in-mold forming method according to claim 2, further comprising:
repeating movement of the mold and intermittent feeding of the patterned film which is continuous, to repeat the embossing and the injection molding simultaneously.

4. The in-mold forming method according to claim 3, further comprising:
the patterned film is a film coated with a metal foil, and
the metal foil of the film coated with the metal foil is transferred, simultaneously with forming, to obtain the formed article decorated with the metal foil.

5. An in-mold forming mold, comprising:
a male mold body;
a film shaping male mold provided, in the male mold body, for embossing, beforehand, a patterned film with a shape conformed to a formed article;
a female mold body;
a film shaping female mold provided, in the female mold body, to oppose the film shaping male mold;
an injection molding male mold provided, in the male mold body, to be adjacent to the film shaping male mold; and
an injection molding female mold provided, in the female mold body, to oppose the injection molding male mold.

6. The in-mold forming mold according to claim 5, wherein
the film shaping male mold is provided in the male mold body via a heat insulating material, and
the film shaping female mold is provided in the female mold body via a heat insulating material.

7. The in-mold forming mold according to claim 6, wherein
the patterned film embossed and injection molded in the male mold body and the female mold body is a film coated with a metal foil, and
the metal foil of the film coated with the metal foil is transferred, simultaneously with forming, to obtain the formed article decorated with the metal foil.

8. An in-mold forming apparatus, comprising:
a stationary support stand for supporting the male mold body according to claim 6;
a moving support stand for supporting the female mold body according to claim 6 to oppose the male mold body;
material pressure-feeding means for pressure-feeding a material for the formed article to a male mold side of the male mold body supported by the stationary support stand;
film feeding means provided, on a moving support stand side, for feeding the patterned film between the male mold body and the female mold body; and
control means for synchronizing a clamping action by movement of the moving support stand, an action of feeding the patterned film by the film feeding means, and an action of pressure-feeding the material for the formed article by the material pressure-feeding means,
the in-mold forming apparatus being arranged to perform, simultaneously,
film shaping and embossing, by the film shaping male mold and the film shaping female mold, of the patterned film to impart the shape conformed to the formed article, and
forming for obtaining the formed article decorated with a pattern of the patterned film by carrying out injection molding, while sandwiching the embossed patterned film between the male mold and the female mold,
and also to repeat feeding of the patterned film upon mold release, thereby obtaining the decorated formed article continuously.

9. The in-mold forming apparatus according to claim 8, wherein
the patterned film is a film coated with a metal foil, and
the metal foil of the film coated with the metal foil is transferred, simultaneously with forming, to obtain the formed article decorated with the pattern of the patterned film.
